(19) United States
(12) Patent Application Publication
(10) Pub. No.: US 2019/0064419 A1
(43) Pub. Date: Feb. 28, 2019

(54) BACKLIGHT MODULE

(71) Applicant: Young Lighting Technology Inc., Hsin-Chu (TW)

(72) Inventor: Yao-Cheng Lue, Hsin-Chu (TW)

(73) Assignee: Young Lighting Technology Inc., Hsin-Chu (TW)

(21) Appl. No.: 15/886,838

(22) Filed: Feb. 2, 2018

(30) Foreign Application Priority Data
Aug. 30, 2017 (CN) 201721096324.5

(51) Int. Cl. F21V 8/00; F21V 21/096

(52) U.S. Cl. CPC G02B 6/009; G02B 6/0031; F21V 21/096

(57) ABSTRACT

The invention is related to a backlight module, including a housing, a light source element and a magnetic element. The light source element includes a light source and a light-guide plate. The light source and the light-guide plate are disposed on the housing. The magnetic element is disposed on one of the light source element and the housing. The light source element is combined with the housing via a magnetic force between the magnetic element and the other one of the light source element and the housing.

### CROSS-REFERENCE TO RELATED APPLICATION

This application claims the priority benefit of China application serial no. 201721096324.5, filed on Aug. 30, 2017. The entirety of the above-mentioned patent application is hereby incorporated by reference herein and made a part of this specification.

### BACKGROUND OF THE INVENTION

### Field of the Invention

The invention is related to an optical module, and particularly to a backlight module.

### Description of Related Art

Along with advancement of semiconductor industries and related electronic industries, smart phones, notebook computers and tablet PCs have been designed to be more convenient and multi-functional with a better appearance. In utilization of the above-mentioned products, display screen is an essential interface. Specifically, liquid crystal display (LCD) device has become the mainstream of display screen. Since the liquid crystal panel of the liquid crystal display device does not emit light, it is required to dispose a backlight module under the liquid crystal panel so as to provide the light required for displaying image.

In conventional assembling method of the backlight module, generally a clamping structure is disposed within a housing of the device or the clamping structure is extended from a back plate of the backlight module to be used to clamp a light source (e.g., light emitting diode light bar) and a light-guide plate therebetween. Also, a particular structure is designed to fix an optical film. However, the clamping structure is varied in size due to manufacturing tolerance, causing the reliability to be reduced after assembling. Moreover, such assembling method requires the light source, the light-guide plate and the optical film to be fixed respectively, which causes the assembling cost and working hour to be increased. Furthermore, the clamping structure is not adapted for backlight modules with different specification; besides, a large amount of molding cost is required for changing the size of clamping structure.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

The invention provides a backlight module with better reliability, which also reduces assembling cost and working hours.

In order to achieve one or a portion or all of the objective or other objective, an embodiment of the invention provides a backlight module, including a housing, a light source element and a magnetic element. The light source element includes a light source and a light-guide plate. The light source and the light-guide plate are disposed on the housing. The magnetic element is disposed on one of the light source element and the housing. The light source element is combined with the housing via a magnetic force between the magnetic element and the other one of the light source element and the housing.

In summary, the embodiment of the invention at least has one of the following advantages or effect. In the backlight module of the invention, the magnetic force generated by the magnetic element is used to combine the light source element with the housing, such that it is not required to use the clamping structure to clamp the light source element therebetween so as to avoid that the reliability of the backlight module reduced due to manufacturing tolerance of the clamping structure. In addition, since the overall light source element is fixed on the housing via the magnetic force, it is not required for the light source, the light-guide plate and the optical film in the light source element to be fixed respectively, and thus the assembling cost and working hour can be reduced. Furthermore, to correspond to the backlight module and the light source element of different sizes, the position of the magnetic element can be adjusted correspondingly, and thus it is not required to develop a mold again due to change of design as in the case of clamping structure, and thus a better utility can be achieved.

Other objectives, features and advantages of the present invention will be further understood from the further technological features disclosed by the embodiments of the present invention wherein there are shown and described preferred embodiments of this invention, simply by way of illustration of modes best suited to carry out the invention.

In order to make the aforementioned features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a partial cross-sectional view of a backlight module according to an embodiment of the invention.

FIG. 2 is a partial cross-sectional view of a backlight module according to another embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

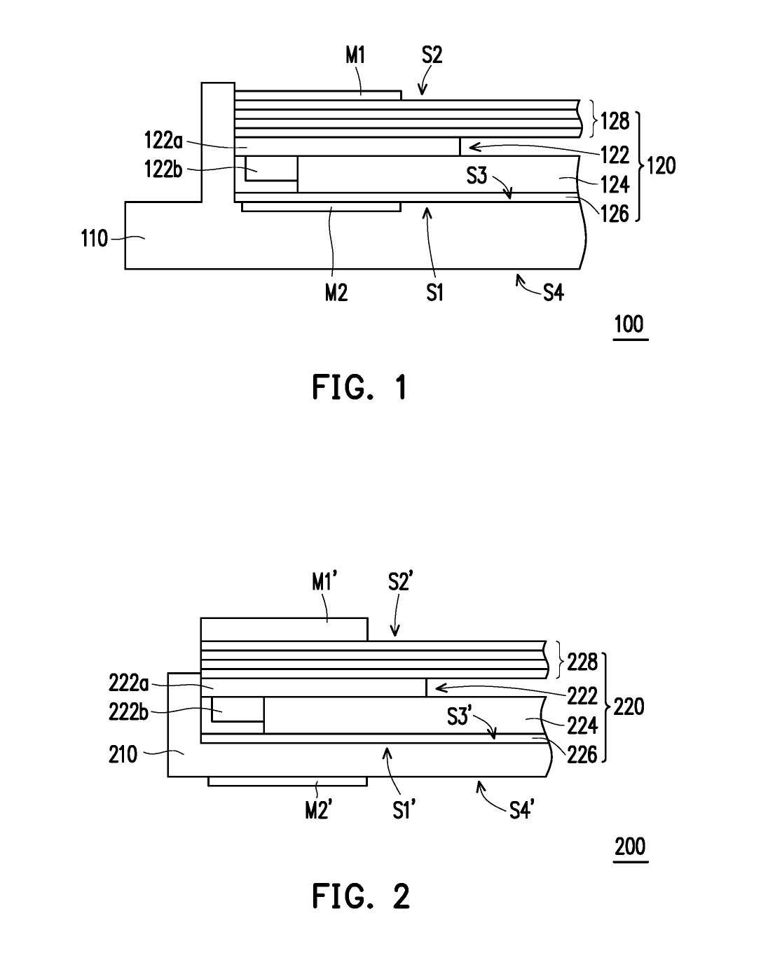

FIG. 1 is a partial cross-sectional view of a backlight module of an embodiment of the invention. Referring to FIG. 1, a backlight module 100 of the embodiment includes a housing 110, a light source element 120, a magnetic element M1 and a magnetic element M2. The light source element 120 includes a light source 122, a light-guide plate 124, a reflective layer 126 and an optical film set 128. The light source 122, the light-guide plate 124, the reflective layer 126 and the optical film set 128 are disposed on the housing 110. The reflective layer 126 is disposed between the housing 110 and the light-guide plate 124. The light-guide plate 124 is disposed between the reflective layer 126 and the light source 122. The light source 122 is disposed between the light-guide plate 124 and the optical film set 128. The magnetic element M1 and the magnetic element M2 are respectively disposed on the light source element 120 and the housing 110. The light source element 120 is combined with the housing 110 via the magnetic force generated between the magnetic element M1 on the light source element 120 and the magnetic element M2 on the housing 110.

By combining the light source element 120 with the housing 110 via the magnetic force generated by the magnetic elements M1 and M2 as described above, it is not required to use a clamping structure to clamp the light source element 120 therebetween, so as to avoid that the reliability of the backlight module is reduced due to the manufacturing tolerance of the clamping structure. In addition, since the overall light source element 120 is fixed on the housing 110 via the magnetic force, it is not required for the light source 122, the light-guide plate 124, the reflective layer 126 and the optical film set 128 in the light source element 120 to be fixed respectively, and thus the assembling cost and working hour can be reduced. Furthermore, to correspond to the backlight module 100 and the light source element 120 of different sizes, the position of the magnetic elements M1 and M2 can be adjusted correspondingly, and thus it is not required to develop a mold again due to change of design as in the case of clamping structure, and thus a better utility can be achieved.

In other embodiment, the magnetic element M1 may be substituted by a magnetism conductor (e.g., a metal element that can be attracted via magnetic force) so as to combine the light source element 120 with the housing 110 via the magnetic force generated between the magnetic element M2 and the magnetism conductor on the light source element. Similarly, the magnetic element M2 may be substituted by the magnetism conductor (e.g., a metal element that can be attracted by magnetic force) so as to combine the light source element 120 with the housing 110 via the magnetic force generated between the magnetic element M1 and the magnetism conductor on the housing. Furthermore, if the housing 110 includes a magnetism conductive material (e.g., a metal material that can be attracted via magnetic force), the magnetic element M2 may not be required, and the light source element 120 can be combined with the housing 110 via the magnetic force generated between the magnetic element M1 and the housing 110.

In the embodiment, the backlight module 100 is, for example, a backlight module applied to a liquid crystal display device. In addition, the light source 122 is, for example, a light emitting diode light bar and includes a substrate 122a and a plurality of light emitting diode elements 122b (one is shown in the drawing). The light emitting diode element 122b is disposed on the substrate 122a. In other embodiment, the backlight module 100 may be applied to other types of device, and the light source may be other types of light emitting element; the invention provides no limitation thereto.

As shown in FIG. 1, the light source element 120 of the embodiment has a first side S1 and a second side S2 opposite to each other. The first side S1 faces the housing 110, and the magnetic element M1 is disposed on the second side S2. In this manner, the light source element 120 is disposed between the magnetic element M1 and the magnetic element M2 on the housing 110 so as to be combined with the housing 110 via the magnetic force generated by the magnetic element M1 and the magnetic element M2.

In the embodiment, the housing 110 is, for example an appearance housing of the display device and provided with a third side S3 and a fourth side S4 opposite to each other. The third side S3 faces the light source element 120. In order to avoid that the magnetic element M2 affects the appearance of the display device, the magnetic element M2 may be disposed on the third side S3 as shown in FIG. 1.

FIG. 2 is a partial cross-sectional view of a backlight module according to another embodiment of the invention. In a backlight module 200 of FIG. 2, a housing 210, a light source element 220, a light source 222, a substrate 222a, a light emitting diode element 222b, a light-guide plate 224, a reflective layer 226, an optical film set 228, a magnetic element M1′, a magnetic element M2′, a first side S1′, a second side S2′, a third side S3′ and a fourth side S4′ are configured and operated similarly to the configuration and operation of the housing 110, the light source element 120, the light source 122, the substrate 122a, the light emitting diode element 122b, the light-guide plate 124, the reflective layer 126, the optical film set 128, the magnetic element M1, the magnetic element M2, the first side S1, the second side S2, the third side S3 and the fourth side S4 in FIG. 1; therefore, no further descriptions are incorporated herein. The difference between the backlight module 200 and the backlight module 100 is that the housing 210 is, for example, a back plate of the backlight module 200 instead of an appearance element of the display device. Accordingly, the magnetic element M2′ may be disposed on the fourth side S4′ of the housing 210 without affecting the appearance of the display device.

In summary, the embodiment of the invention at least has one of the following advantages or effect. In the backlight module of the invention, the magnetic force generated by the magnetic element is used to combine the light source element with the housing, such that it is not required to use a clamping structure to dispose the light source element therebetween, so as to avoid that the reliability of the backlight module is decreased due to manufacturing tolerance of the clamping structure. In addition, since the overall light source element is fixed on the housing via the magnetic force, it is not required for the light source, the light-guide plate and the optical film set in the light source element to be fixed respectively, and thus the assembling cost and working hour can be reduced. Furthermore, to correspond to backlight module and light source element of different sizes, the position of the magnetic element can be adjusted correspondingly, and thus it is not required to develop a mold again due to change of design as in the case of clamping structure, and thus a better utility can be achieved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, comprising: a housing, a light source element and a magnetic element,
the light source element comprises a light source and a light-guide plate, wherein the light source and the light-guide plate are disposed on the housing;
the magnetic element is disposed on one of the light source element and the housing, wherein the light source element is combined with the housing via a magnetic force between the magnetic element and the other one of the light source element and the housing.

2. The backlight module according to claim 1, wherein the magnetic element is disposed on the light source element, the housing is provided with another magnetic element, and the magnetic force is generated between the two magnetic elements.

3. The backlight module according to claim 1, wherein the magnetic element is disposed on the light source element, the housing is provided with a magnetism conductor, the magnetic force is generated between the magnetic element and the magnetism conductor.

4. The backlight module according to claim 1, wherein the magnetic element is disposed on the housing, the light source element is provided with another magnetic element, the magnetic force is generated between the two magnetic elements.

5. The backlight module according to claim 1, wherein the magnetic element is disposed on the housing, the light source element is provided with a magnetism conductor, the magnetic force is generated between the magnetic element and the magnetism conductor.

6. The backlight module according to claim 1, wherein the light source element further comprises a reflective layer and an optical film set, the reflective layer is disposed between the housing and the light-guide plate, the light-guide plate is disposed between the reflective layer and the light source, and the light source is disposed between the light-guide plate and the optical film set.

7. The backlight module according to claim 1, wherein the light source element comprises a first side and a second side opposite to each other, the first side faces the housing, and the magnetic element is disposed on the second side.

8. The backlight module according to claim 1, wherein the housing comprises a third side and a fourth side opposite to each other, the first side faces the light source element and the magnetic element is disposed on the third side or the fourth side.

9. The backlight module according to claim 1, wherein the backlight module is adapted for a display device, and the housing is an appearance housing of the display device.

10. The backlight module according to claim 1, wherein the housing is a back plate of the backlight module.
